(19) United States
(12) Patent Application Publication
(10) Pub. No.: US 2005/0084015 A1
(43) Pub. Date: Apr. 21, 2005

(54) Bit-rate control method and apparatus for normalizing visual quality

(75) Inventors: Woo-jin Han, Suwon-si (KR); Bae-keun Lee, Bucheon-si (KR); Ho-jin Ha, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/968,491

(22) Filed: Oct. 20, 2004

Related U.S. Application Data
(60) Provisional application No. 60/512,196, filed on Oct. 20, 2003.

(30) Foreign Application Priority Data
Nov. 22, 2003 (KR) 10-2003-0083338

(51) Int. Cl. H04N 7/12

(52) U.S. Cl. 375/240.19; 375/240.01

(57) ABSTRACT

A scalable video codec includes an encoder that encodes an original moving picture; a rate control unit that allocates an optimal amount of bits for each coding unit based on a bit-rate desired by a user; a pre-decoder that receives a bit-stream and extracts a bit-stream having an appropriate amount of bits; and a decoder that decodes image sequences of the moving picture from the extracted bit-stream, so as to reconstruct the original moving picture. In particular, the present invention focuses on the operation performed in the rate control unit 340. The rate control unit operates a definition step of a bit-rate function available for use in the predecoder, a pre-summation step to thereby obtain the uniform visual quality, an approximation to determine the distortion function, and a normalization step to allow the total allocated bit-rates to be equal to a target bit-rate.

### BACKGROUND OF THE INVENTION

This application is based on and claims priority from U.S. Provisional Patent Application No. 60/512,196 filed on Oct. 20, 2003 in the United States Patent and Trademark Office and Korean Patent Application No. 10-2003-0083338 filed on Nov. 22, 2003 in the Korean Intellectual Property Office, the disclosures of which are incorporated herein by reference.

1. Field of the Invention

The present invention relates to video coding. More particularly, the present invention relates to a method and an apparatus for controlling bitrates by use of information available to a pre-decoder so as to minimize the peak signal-to-noise ratio (PSNR) variancein a wavelet-based scalable video coding using the pre-decoder.

2. Description of the Related Art

Scalable video coding (allowing partial decoding at various resolutions, qualities and temporal levels from a single compressed bitstream) is widely considered a promising technology for efficient signal representation and transmission in heterogeneous environments. Although MPEG-4 Fine Granularity Scalability (FGS) is established as a signal-to-noise ratio (SNR) and temporal scalable video coding standard, many wavelet-based scalable video coding schemes have already demonstrated their potential for SNR, spatial, and temporal scalability. Detailed information on MPEG-4FGS may be obtained from a report published by Mr. W. Li, “Overview of fine granularity scalability in MPEG-4 video standard,”(IEEE Trans. Circuits Syst. Video Technol., vol. 11, pp. 301-317, March 2001.).

FIG. 1 is a block diagram illustrating an overall configuration of a video codec based on a conventional rate-distortion (R-D) optimization art. The video codec 100 includes a rate control module 130 that chooses an optimal quantization step or an amount of optimal bits for each coding unit, an encoder 110 that generates a bit-stream 40 whose bandwidth is limited, and a decoder 120 that reconstructs image-sequences 20 from the bandwidth-limited bit-stream 40. In the conventional art, the rate-control is only performed in the encoder 110.

FIG. 2 is a block diagram illustrating an operational configuration of a wavelet-based scalable video codec according to the conventional art.

Although rate control algorithms generally improve R-D performance, the conventional methods all utilize prediction error information that is only usable in the encoding phase, which implies that the rate control should be done in the encoder 210. For most applications that require fully scalable video coders, the encoder 210 should generate a sufficiently large bit stream 35 such that a pre-decoder or transcoder 220 extracts an adequate amount of bits 40 from the bit stream while considering quality, temporal, and spatial requirements. The conditions for extracting an appropriate amount of bit-stream consistent with quality, temporal and spatial requirements are referred to as scalability conditions. Then, a decoder 230 can recover a video sequence 20 from the truncated bit stream 40.

The rate control should be done in a pre-decoder 220 instead of the encoder because the actual bit-rate is determined in the pre-decoder 220. There has been little research on rate control algorithms in the pre-decoder 220, and most research has focused on a constant bit-rate (CBR) scheme. However, Mr. Hsiang suggests a variable bit-rate (VBR) scheme in his PhD dissertation, “Highly scalable subband/wavelet image and video coding, “(Rensselaer Polytechnic Institute, New York, January 2002.),” which can also be used in a pre-decoder (hereinafter referred as “Hsiang's scheme”). In this scheme, wavelet bit planes used in the pre-decoder are identical in number in order to enhance performance of the conventional CBR scheme.

Hereinbelow, Hsiang's scheme will be described in detail.

In the following description, the transmitted video can be partitioned into multiple group-of-pictures (GOP), with each GOP having multiple frames. This can simplify a rate allocation algorithm because each GOP is separately encoded. Thus, each GOP is independent from one another, however, each frame in a GOP is heavily correlated with one another. If B_{T} is the total bits for an entire video sequence that consists of N GOPs, the rate-allocation problem can be formulated as

$$\{ R ( 1 ) , … , R ( N ) \} = arg {min}_{\{ R ( 1 ) , … , R ( N ) \}} {\sum }_{i = 1}^{N} D ( i ) \qquad Formula 1$$

where R(i) is the allocated bits for the i-^{th} GOP and D(i) is absolute difference between original and decoded frames. A fundamental aspect of the VBR method is to allocate more bits to relatively complex scenes and less bits to the others in order to achieve better R-D performance or visual quality. If we define scene complexity as the degree of difficulty for encoding the given image frame, the amount of allocated bits for a GOP, with a constant number of used wavelet bitplanes, is highly correlated with the relative scene complexity among GOPs. From this fact, Hsiang's scheme proposes that the VBR scheme equalize the number of bitplanes used for all the frames.

If b(i, j) is the number of encoded bits for the i-^{th} GOP and the j-^{th} bitplane and B(i, k) represents the number of accumulated encoded bits using k bitplanes, then B(i, k) is defined as

$$B ( i , k ) = {\sum }_{j = 1}^{k} b ( i , j ) \qquad Formula 2$$

If the number of bitplanes used is a constant value K for all the frames, then B(i, K) gives some statistics of scene complexity for the i-^{th} frame with the total allocated bits, A(K), given by

$$A ( K ) = {\sum }_{i = 1}^{N} B ( i , K ) \qquad Formula 3$$

where N is total number of GOPs. If K* represents an integer number of bitplanes whose total amount of allocated bits is closest to B_{T}, the final allocated bits for the ith GOP, Rₒ(i), can be given by
Rₒ(i)=B(i, K*) Formula 4
where
A(K−1)≦B_{T}<A(K) Formula 5

By using a linear interpolation technique, it may be possible to obtain more accurate statistics of scene complexity by making the total encoded bits equal to B_{T}.

Wavelet-based scalable vide coding inherently employs the property of embedding, and thus, it is appropriate to use it in a variable bit-rate (VBR) algorithm. On this point, although Hsiang's scheme is simple and effective, it needs further improvement in order to reduce the variation of PSNR values since it focuses merely to minimize the objective error measure. Even if the average PSNR is sufficiently high, noticeable visual artifacts can be observed in the low PSNR frames if the PSNR variance is high. Therefore, it is valuable to have a bit allocation scheme that minimizes the PSNR variance.

### SUMMARY OF THE INVENTION

In view of the above, a method for allocating bits using information available on a pre-decoder side is provided so as to allow a decoder side to have an optimal quality.

A method of allocating variable bit-rates is also provided so as to minimize PSNR variance in the wavelet-based scalable video coding.

According to an aspect of the present invention, there is provided a bit-rate control method comprising, a first step of determining an amount of bits for each coding unit from a bit-stream generated by encoding an original moving picture, so as to allow a visual quality of the moving picture to be uniform relative to the coding units thereof; and a second step of extracting a bit-stream having the amount of bits as desired by truncating a part of the bit-stream based on the determined bit amount.

According to another aspect of the present invention, there is provided a bit-rate control apparatus comprising, a first means for determining a bit amount for each coding unit from a bit-stream generated by encoding an original moving picture, so as to make the visual quality of the moving picture uniform relative to the coding unit thereof; and a second means for extracting a bit-stream having the amount of bits as desired by truncating a part of the bit-stream based on the determined bit amount.

### BRIEF DESCRIPTION OF THE DRAWINGS

The above and other objects, features and advantages of the present invention will be readily apparent from the following detailed description of exemplary embodiments when taken in conjunction with the accompanying drawings, in which:

FIG. 1 is a block diagram illustrating an overall configuration of a video codec based on the conventional rate-distortion optimization art;

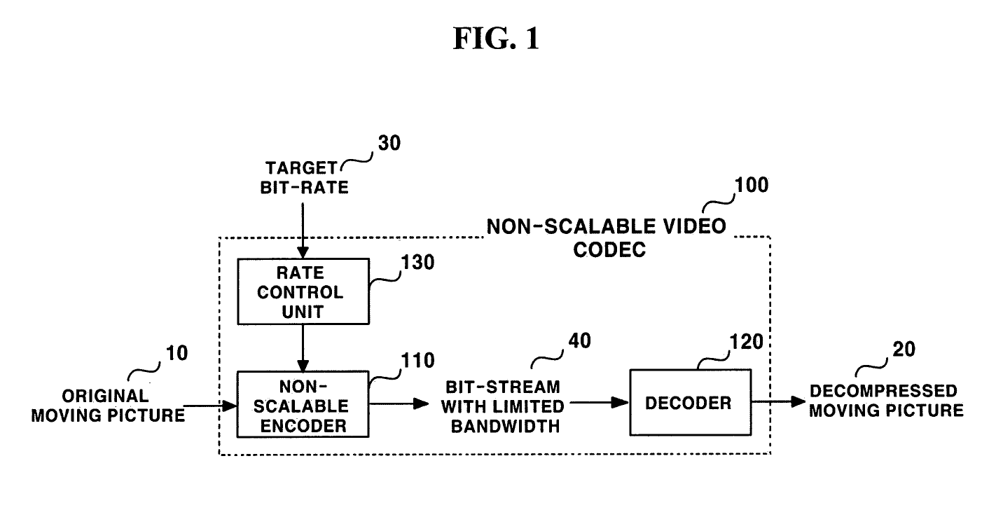

FIG. 2 is a block diagram illustrating an operational configuration of a wavelet-based scalable video codec according to the conventional art;

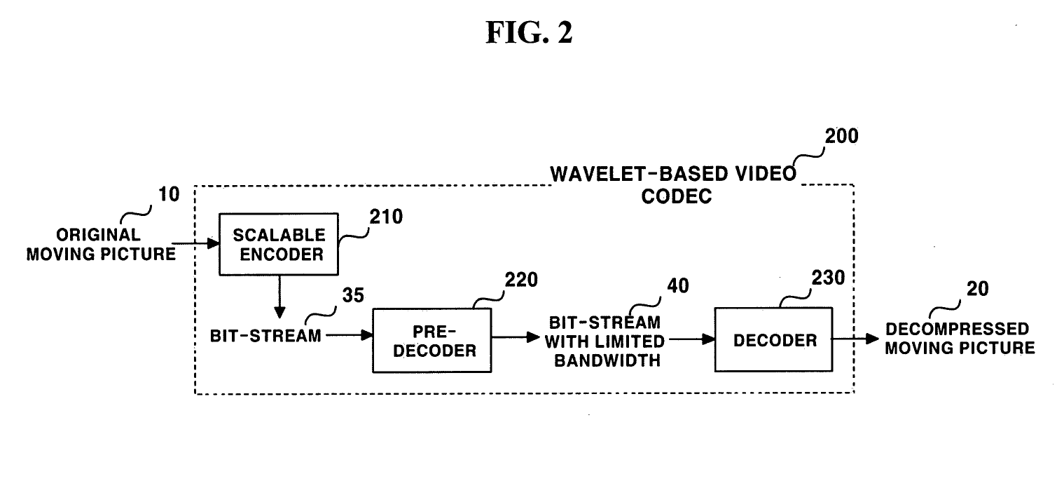

FIG. 3 is a block diagram illustrating an operational configuration of a wavelet-based scalable video codec according to an exemplary embodiment of the present invention;

FIG. 4 is a graph illustrating a comparison of D(i)/D and B(i, K*) in an encoded Canoa QCIF (Quarter Common Interchange format) sequence;

FIG. 5A is a graph illustrating a bit-rate allocated for each GOP in a Football QCIF sequence;

FIG. 5B is a graph illustrating an average PSNR for each GOP in a Football QCIF sequence;

FIGS. 6A and 6B illustrate examples of the 92-^{th} frame of a Foreman QCIF sequence coded to VBR-D and VBR-N, respectively; and

FIGS. 7A and 7B illustrate examples of the 106-^{th} frame of a Foreman QCIF sequence coded to VBR-D and VBR-N, respectively.

### DETAILED DESCRIPTION OF AN ILLUSTRATIVE, NON-LIMITING EMBODIMENT OF THE INVENTION

Hereinafter, an exemplary embodiment of the present invention will be described in detail with reference to the accompanying drawings.

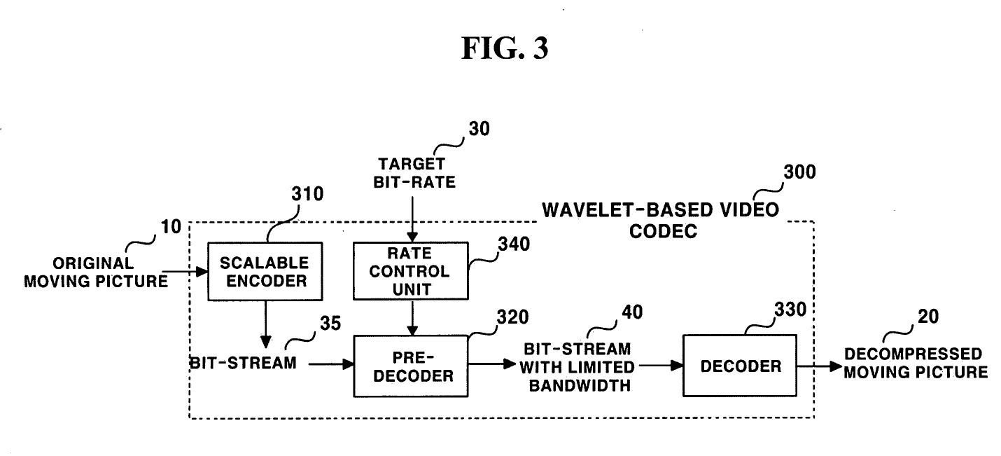

FIG. 3 is a block diagram illustrating an operational configuration of a wavelet-based scalable video codec according to an exemplary embodiment of the present invention.

A scalable video codec 300 includes an encoder 310 that encodes an original moving picture 10 so as to generate a sufficiently large bit-stream 35; a rate control unit 340 that allocates the optimal amount of bits for each coding unit based on a bit-rate 30 desired by a user; a pre-decoder 320 that receives the bit-stream 35 and extracts a bit-stream 40 having an appropriate amount of bits by truncating a part of the received bit-stream 35, based on the optimal amount of bits selected in the rate control unit 340; and a decoder 330 that decodes image sequences of the moving picture from the extracted bit-stream 40, so as to reconstruct the original moving picture.

In particular, the present invention focuses on the operation performed in the rate control unit 340. The rate control unit 340 comprises four steps and operates a definition step of a bit-rate function available for use in the predecoder 320 by using a bit distribution and a distortion function with a constant number of bitplanes, a pre-summation step of the bit-rate by modifying the bit-rate function to thereby obtain the uniform visual quality, an approximation step of the distortion function by use of the bit distribution to determine the distortion function, and a normalization step of the modified bit-rate function to allow the total allocated bit-rates to be equal to a target bit-rate. Because the assessed visual quality of a picture is generally based on the PSNR, PSNR is also employed in the present invention as a criterion for quality assessment. Additionally, Mean Absolute Distribution (MAD) information, used in the conventional encoder, is replaced with bit distribution of the constant number of bitplanes as a scene complexity function.

The definition step of a bit-rate function available for use in the predecoder by using a bit distribution and a distortion function with a constant number of bitplanes will be described. Similar to Formula 6, let us assume that the source statistics are Laplacian distributed.

$$P ( x ) = \frac{α}{2} {ⅇ}^{- a \vert x \vert} \qquad Formula 6$$

where α is a constant.

If a difference function is used as a distortion measure, then there is a closed form solution for the rate distortion function as derived in Formula 7. D(i) denotes a distortion function, indicating a difference between the original image and the final image after decompression.

$$\frac{R ( i )}{M ( i )} = ln ( \frac{1}{α D ( i )} ) \qquad Formula 7$$

The R-D function can be further modified by introducing two new parameters: MAD and nontexture overhead Formula 8.

$$\frac{R ( i ) - H ( i )}{M ( i )} = ln ( \frac{1}{α D ( i )} ) \qquad Formula 8$$

In Formula 8, H(i) denotes the bits used for header information and motion vectors, and M(i) denotes the MAD computed using motion-compensated residual for a luminance component. MAD is included in an R-D function in order to consider scene complexity since more bits should be used for relatively complex frames and less bits for others at the same target bit-rate limitation.

Although the conventional VBR scheme uses B(i, K*) as the allocated bits, the present invention uses B(i, K*) to replace M(i) since B(i, K*) is highly correlated with the scene complexity for ith GOP. By replacing M(i) with B(i, K*), the following is yielded.

$$\frac{R ( i )}{B ( i , {K}^{*} )} = ln ( \frac{1}{α D ( i )} ) \qquad Formula 9$$

For notational simplicity, the nontexture overhead, H(i) is not considered in Formula 9 and the remaining text of this description since it is a trivial problem. In the inventors' preliminary experiments, it has been shown that, by choosing the optimal value of α, this replacement is reasonable for many combinations of bit-rates, resolution, and sequences.

The pre-summation step of the bit-rate obtains the uniform visual quality by modifying the bit-rate function and will now be described.

If D is the average value of D(i) for all GOPs, then adding In (D(i)/D) to both sides of Formula 9 gives

$$\begin{matrix}\frac{{R}^{′} ( i )}{B ( i , {K}^{*} )} = ln ( \frac{1}{α D} ) \\ where & Formula 10 \\ {R}^{′} ( i ) = R ( i ) + B ( i , {K}^{*} ) ln ( \frac{D ( i )}{D} ) & Formula 1\end{matrix}$$

Since the right side of Formula 10 is a constant value, it follows that allocating R′(i) bits for i-th GOP results in a constant distortion. To obtain R′(i), R(i) and In (D(i)/D) should be computed as shown in Formula 11. However, this may be a difficult problem since the actual distortion D(i) cannot be determined in the pre-decoder.

The approximation step of the distortion function by use of the bit distribution to determine the distortion function will now be described.

To solve the above problem, the initial bit allocation R(i) is first set equal to Rₒ(i) as described above, and D(i)/D is estimated by some approximations. In Formula 11, D(i)/D is the ratio of the relative magnitude of distortion to the average distortion. Because a relative magnitude of distortion increases when the scene complexity does, it is assumed that D(i)/D can be represented in terms of the scene complexity function, B(i, K*), as

$$\begin{matrix}\frac{D ( i )}{D} \approx \frac{B ( i , {K}^{*} )}{B} \\ where & Formula 12 \\ B = \frac{1}{N} {\sum }_{n = 1}^{N} {B ( i , {K}^{*} )}^{r} & Formula 13\end{matrix}$$

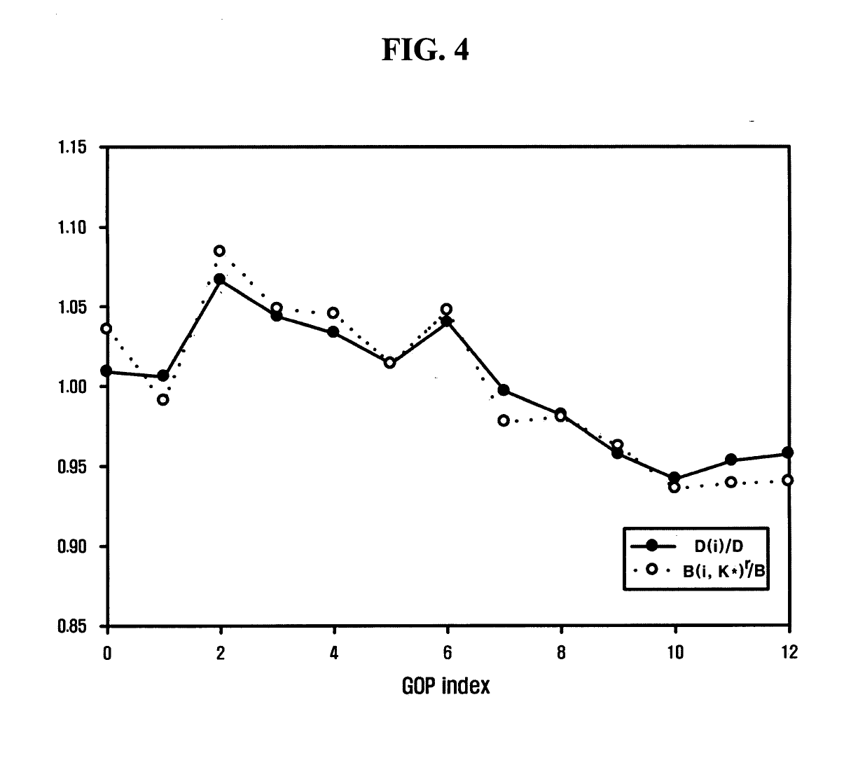

and r is an experimental constant used to compensate for the nonlinearity between the actual distortion and the allocated bits. FIG. 4 shows the comparison graph of D(i)/D and B(i, K*)/B in Canoa QCIF sequence encoded at 512 kbps with the value of r=0.4. As shown in FIG. 4, D(i)/D, can be roughly modeled by the relative scene complexity, B(i, K*)^{r}/B. Furthermore, from the exhaustive preliminary experiments, it has been shown that the value of r=0.4 is satisfactory for almost all the test conditions.

Inserting Formula 12 to Formula 11 yields

$${R}^{′} ( i ) = {R}_{o} ( i ) + B ( i , {K}^{*} ) ln ( \frac{{NB ( i , {K}^{*} )}^{r}}{{\sum }_{j = 1}^{N} {B ( j , {K}^{*} )}^{r}} ) \qquad Formula 14$$

The normalization step of the modified bit-rate function to allow the total allocated bit-rates to be equal to a target bit-rate will now be described.

Since R′(i) is modified from R(i) without considering the bit-rate limitation, R′(i) should be normalized to meet the target bit-rate requirement. Simple normalization gives a final equation defined as

$${R}_{n} ( i ) = \frac{{R}^{′} ( i ) {B}_{T}}{{\sum }_{j = 1}^{N} {R}^{′} ( i )} \qquad Formula 15$$

where Rₙ(i) is the allocated bits for i-th GOP, which can flatten the distortion.

CBR indicates the conventional scheme for constant bit-rate allocation, VBR-D indicates variable rate allocation according to Hsiang's scheme, and VBR-N indicates variable rate allocation according to the present invention. As shown in Table 1, the VBR-N scheme outperforms the CBR scheme's Foreman OCIF and Canoa OCIF by a clear margin up to 0.9 dB and 0.6 dB, respectively, due to VBR-N scheme's efficient realization of adaptive bit allocation technique. In addition, all performance gaps between the VBR-D and the VBR-N are limited within about 0.2 dB for both sequences.

TABLE 1

| | | | |
|---|---|---|---|
| Bit-rate (kbps) | CBR | VBR-D | VBR-N |

Foreman QCIF@30 Hz

| | | | |
|---|---|---|---|
| 64 | 27.57 | 27.98 | 27.80 |
| 128 | 32.30 | 32.93 | 32.71 |
| 256 | 36.40 | 37.05 | 36.90 |
| 384 | 38.91 | 39.40 | 39.31 |
| 512 | 40.73 | 41.21 | 41.17 |
| 768 | 43.63 | 43.97 | 43.91 |

Canoa QCIF@30 Hz

| | | | |
|---|---|---|---|
| 64 | 23.43 | 23.59 | 23.54 |
| 128 | 26.34 | 26.48 | 26.41 |
| 256 | 29.26 | 29.42 | 29.40 |
| 384 | 31.39 | 31.53 | 31.50 |
| 512 | 33.27 | 33.44 | 33.40 |
| 768 | 36.31 | 36.48 | 36.46 |

Table 2 shows the standard deviation of PSNR values using CBR, VBR-D, and VBR-N. First, this table reveals that VBR-D and VBR-N schemes reduce the PSNR standard deviation more than the CBR scheme. In the standard deviation of PSNR obtained per each frame, VBR-N reduces it by 23% to 50.8% in comparison with VBR-D, although it has not expressly been shown. Since VBR-N employs an optimization technique based on GOP, the percentage of reduction becomes very large, in the standard deviation of PSNR obtained by each GOP, so called, GOP-average PSNR standard deviation. This demonstrates that VBR-N scheme is more effective in making the overall PSNR curve flat. Referring to Table 2, VBR-N reduces GOP-average PSNR standard deviation by 26.1% to 89.7% in comparison with VBR-D.

TABLE 2

| | | | | |
|---|---|---|---|---|
| Bit-rate (kbps) | CBR | VBR-D | VBR-N | 1-VBR-N/VBR-D(%) |

Foreman QCIF@30 Hz

| | | | | |
|---|---|---|---|---|
| 64 | 1.93 | 1.51 | 0.73 | 51.7 |
| 128 | 2.44 | 1.92 | 1.00 | 47.7 |
| 256 | 2.33 | 1.69 | 0.48 | 71.3 |
| 384 | 2.06 | 1.34 | 0.26 | 80.9 |
| 512 | 1.89 | 1.19 | 0.25 | 79.4 |
| 768 | 1.61 | 0.97 | 0.32 | 67.5 |

Canoa QCIF@30 Hz

| | | | | |
|---|---|---|---|---|
| 64 | 1.29 | 1.10 | 0.81 | 26.1 |
| 128 | 1.23 | 0.98 | 0.50 | 49.1 |
| 256 | 1.22 | 0.88 | 0.23 | 74.0 |
| 384 | 1.17 | 0.75 | 0.08 | 89.7 |
| 512 | 1.14 | 0.76 | 0.10 | 87.4 |
| 768 | 1.12 | 0.69 | 0.21 | 69.2 |

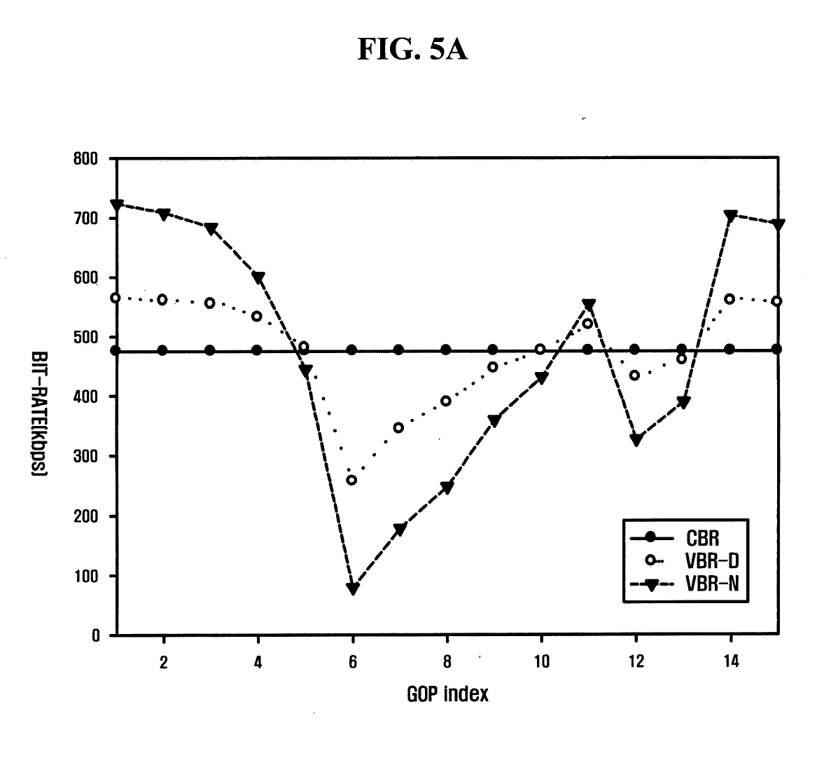

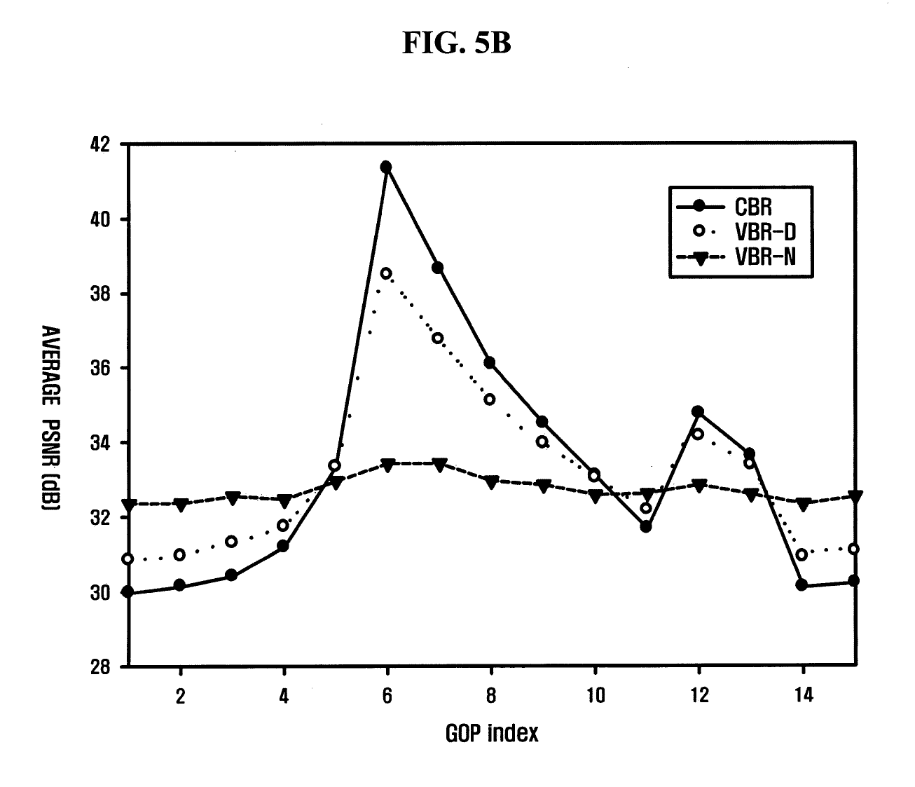

FIG. 5A is a graph illustrating a bit-rate allocated for each GOP in a Football QCIF sequence, and 5B is a graph illustrating an average PSNR for each GOP in a Football QCIF sequence. Football QCIF is encoded at an average bit-rate of 512 kbps. Moreover, we illustrate GOP-averaged PSNR instead of frame PSNR to investigate the overall flatness of the PSNR curve. In FIG. 5A, the bit-rates of CBR are almost constant and those of VBR-D and VBR-N are highly variable since they are optimized by scene characteristics, which are highly variable. On the other side, the GOP-averaged PSNR curve of VBR-N is much flatter than that of CBR and VBR-D.

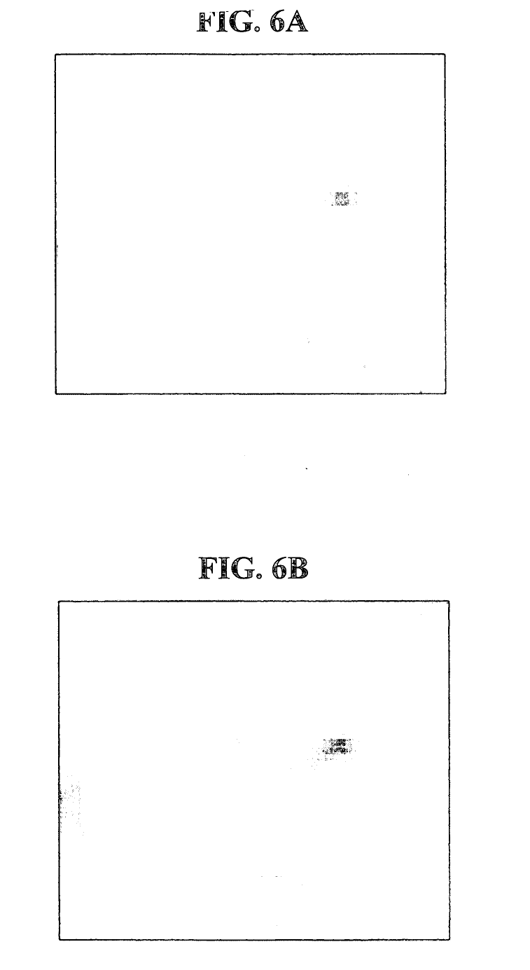

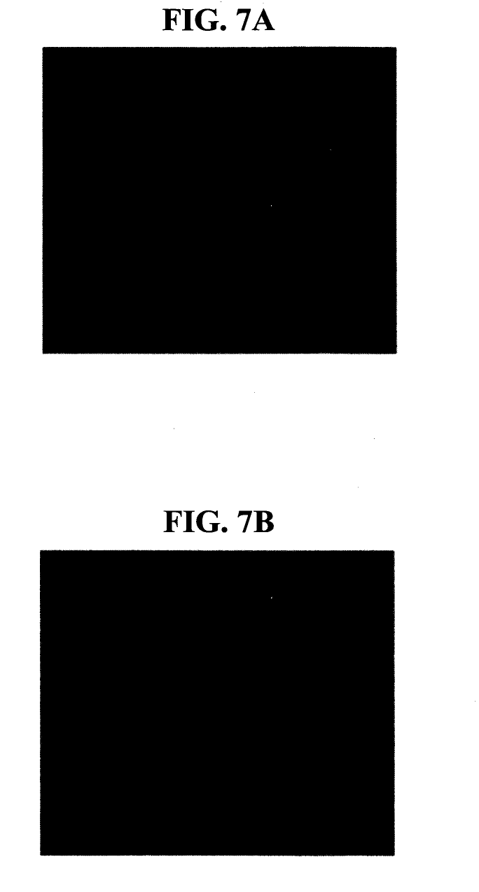

FIGS. 6A, 6B, 7A and 7B illustrate several examples of coding Foreman QCIF sequences.

FIG. 6A illustrates the 92-^{th} frame (PSNR=38.02) generated by VBR-D and FIG. 6B illustrates the 92-^{th} frame (PSNR=39.94) generated by VBR-N on the same position.

As shown in these figures, VBR-N reduces an artifact significantly. It is a natural result since VBR-N can flatten the PSNR curve with a slightly smaller average PSNR, thus, the minimum value of PSNR increases significantly.

FIG. 7A illustrates the 106-^{th} frame (PSNR=44.05) generated by VBR-D and FIG. 7B illustrates the 106-^{th} frame (PSNR=44.02) generated by VBR-N.

As shown in these figures, although the PSNR value of VBR-D is higher than that of VBR-n, the actual visual quality is almost the same because both PSNR values are high enough to make coding artifacts imperceptible. This property is very useful for subjective visual quality because the visual quality can be controlled in a more perceptual sense by improving the PSNR of poor quality frames by sacrificing that of very good quality frames.

According to the present invention, the PSNR standard deviation may be greatly reduced while maintaining almost the average PSNR as it is. This property is very useful for subjective visual quality because the visual quality can be controlled in a more perceptual sense by improving the PSNR of poor quality frames by sacrificing that of very good quality frames.

According to the present invention, since information available only on the pre-decoder side is used, the pre-decoder needs no additional information.

Although the present invention has been described in connection with the preferred embodiment of the present invention, it will be apparent to those skilled in the art that various modifications and changes may be made thereto without departing from the scope and spirit of the invention. Therefore, it should be understood that the above embodiment is not restrictive but illustrative in all aspects. The scope of the present invention is defined by the appended claims rather than the detailed description of the invention. All modifications and changes derived from the scope and spirit of the claims and equivalents thereof should be construed to be included in the scope of the present invention.

1. A bit-rate control method, comprising:
determining an amount of bits for each of a plurality of coding units from a bit-stream generated by encoding an original moving picture, so as to allow a visual quality of the moving picture to be uniform relative to the coding units thereof; and
extracting a bit-stream having the amount of bits by truncating a part of the bit-stream based on the determined bit amount.

2. The method as claimed in claim 1, wherein a peak signal-to-noise ratio (PSNR) is employed as a reference for measuring the visual quality.

3. The method as claimed in claim 1, wherein the bitstream generated by an encoder follows a wavelet-based video coding scheme and is modified adaptively to a scalability condition by the pre-decoder.

4. The method as claimed in claim 1, wherein a flattening of a quality measuring reference is performed by increasing the bits allocated for a first coding unit and decreasing the bits allocated for a second coding unit, and
wherein the first coding unit has a lower quality image than the second coding unit.

5. The method as claimed in claim 1, wherein the determination of the bit amount includes:
defining a bit-rate function available in the pre-decoder by using a bit distribution and a distortion function with a constant number of bitplanes; and
presuming the bit-rate by modifying the bit-rate function, so as to obtain uniform visual quality.

6. The method as claimed in claim 5, wherein the determination of the bit amount further includes initially approximating the distortion function, with the use of the bit distribution, to determine the distortion function with information useable in the pre-decoder.

7. The method as claimed in claim 6, wherein the determination of the bit amount further includes normalizing the bit-rate function by modifying the bit-rate function so that a total allocated bit-rate is equal to a target bit-rate.

8. A bit-rate control apparatus, comprising:
a first means for determining a bit amount for each of a plurality of coding units from a bit-stream generated by encoding an original moving picture, so as to make the visual quality of the moving picture uniform relative to the coding units thereof; and
a second means for extracting a bit-stream having the amount of bits by truncating a part of the bit-stream based on the determined bit amount.

9. The apparatus as claimed in claim 8, wherein the bitstream created by an encoder, which follows a wavelet-based video coding scheme, is modified adaptively to a scalability condition by the pre-decoder.

10. The apparatus as claimed in claim 8, wherein the first means includes a means for defining a bit-rate function available in the pre-decoder by using a bit distribution and a distortion function with a constant number of bitplanes, and presuming the bit-rate by modifying the bit-rate function, so as to obtain uniform visual quality.

11. The apparatus as claimed in claim 10, wherein the first means further includes a means for initially approximating the distortion function, with the use of the bit distribution, to determine the distortion function with information useable in the pre-decoder.

12. The apparatus as claimed in claim 10, wherein the first means further includes a means for normalizing the bit-rate function by modifying the bit-rate function so that a total allocated bit-rate equals a target bit-rate.

13. A computer-readable recording medium for recording a computer program code for enabling a computer to provide a service of a bit-rate control method, comprising;
determining an amount of bits for each of a plurality of coding units from a bit-stream generated by encoding an original moving picture, so as to allow a visual quality of the moving picture to be uniform relative to the coding units thereof; and
extracting a bit-stream having the amount of bits by truncating a part of the bit-stream based on the determined bit amount.

14. A bit-rate control apparatus, comprising:
a determining unit determining a bit amount for each of a plurality of coding units from a bit-stream generated by encoding an original moving picture, so as to make the visual quality of the moving picture uniform relative to the coding units thereof; and
an extracting unit extracting a bit-stream having the amount of bits by truncating a part of the bit-stream based on the determined bit amount.

15. The apparatus as claimed in claim 14, wherein the bitstream created by an encoder follows a wavelet-based video coding scheme and is modified adaptively to a scalability condition by the pre-decoder.

16. The apparatus as claimed in claim 14, wherein the determining unit includes a defining unit defining a bit-rate function available in the pre-decoder by using a bit distribution and a distortion function with a constant number of bitplanes, and a pre-summation unit modifying the bit-rate function so as to obtain uniform visual quality.

17. The apparatus as claimed in claim 16, wherein the determining unit further includes an approximating unit that initially approximates the distortion function, with the use of the bit distribution, in order to determine the distortion function with information useable in the pre-decoder.

18. The apparatus as claimed in claim 16, wherein the determining unit further includes a normalizing unit normalizing the bit-rate function by modifying the bit-rate function so that a total allocated bit-rate equals a target bit-rate.
